(19) United States
(12) Patent Application Publication
(10) Pub. No.: US 2026/0061774 A1
(43) Pub. Date: Mar. 5, 2026

(54) BICYCLE COMPONENT

(71) Applicant: DT SWISS INC., Grand Junction, CO (US)

(72) Inventors: Thomas GASSER, Detligen (CH); Nicholas OMLIN, Rapperswil (CH); Andreas TSCHANZ, Legnau (CH); Timo PRIES, Spardorf (DE)

(21) Appl. No.: 19/312,596

(22) Filed: Aug. 28, 2025

(30) Foreign Application Priority Data
Sep. 2, 2024 (DE) 102024125031.3

(51) Int. Cl. B60B 27/02; B60B 27/00

(52) U.S. Cl. CPC B60B 27/023; B60B 27/0031

(57) ABSTRACT

A bicycle component for a bicycle freewheel unit, wherein the freewheel unit includes a rotary unit and a toothed disk device coupled with the rotary unit. The toothed disk device includes an end toothing with axial engagement components for engaging corresponding engagement components of another toothed disk device. The toothed disk device and the rotary unit are each configured as coupling components coupled to one another, and include a radial toothing each, for engaging with one another, and which are commonly rotatable. The rotary unit and the toothed disk device are movable in a peripheral direction relative to one another between a driving position and a rest position, so that prior to torque transmission starting, a coupling component is rotated in the driving direction about a clearance angle of at least 5°, until torque can be transmitted, when the two radial toothings have previously been in the rest position.

The present invention relates to a bicycle component for an at least partially muscle-powered vehicle and in particular a bicycle, and comprises at least one freewheel unit of a freewheel device. A freewheel unit comprises a rotary unit and a toothed disk device provided to be coupled with the rotary unit. The toothed disk device comprises an end toothing with axial engagement components, suitable for engaging with corresponding engagement components of another toothed disk device. The rotary unit and the toothed disk device are configured as coupling components provided to be coupled, each comprising a radial toothing for intermeshing, and rotatable around a shared, central rotation axis.

The prior art has disclosed a great variety of bicycle components with freewheels. As a rule, rear wheel hubs are equipped with a freewheel, wherein the applicant prefers using toothed disk freewheels comprising two toothed disk devices with end toothings. The axial engagement components on the end faces are in engagement with one another for torque transmission, and in the freewheeling state they are separated from one another in the axial direction.

In many cases, rear wheel hubs with a ratchet freewheel are employed, provided with multiple ratchet pawls which, for torque transmission, raise to an upright position around an axis in parallel to the hub axle, and engage with the internal toothing of the hub shell with the radially outwardly end of the ratchet pawl. As the rider stops pedalling, the ratchet pawls disengage, resulting in the freewheeling state.

In particular in full suspension bicycles, off-road downhill rides or jumps may result in slight changes to the drive system geometry, so that in subsequent compressing, the rear wheel hub rotor may accelerate, to thus cause the freewheel to couple and the chain to rotate backward inadvertently, although the rider is not pedaling or otherwise actuating the pedal. Then, the rider feels what is known as a pedal kickback, which may be unpleasant. This reverse chain drive causes a pedal kickback, adversely affecting the rider's body and his performance. This applies even if riders tend to not always recognize a pedal kickback per se on rough and uneven roads.

In order to prevent pedal kickbacks, O-Chain (https://www.ochain.bike/pages/for-nerds) has developed a mechanism for mounting to the pedal crank, providing an adjustable angular range outside of which a torque transmission will be effective as pedaling is started. Thus, a pedal kickback is accordingly prevented respectively the rider will not feel it. The system known in the market shows satisfactory function. There is the drawback, however, that an additional component is required, rendering the entire system more complex, and moreover requiring maintenance.

US 2024/0157728 A1 has disclosed a bicycle hub equipped with a ratchet freewheel, and provided for setting a dead angle from which torque transmission begins. To this end, an adjusting component is mounted on the pawl bracket to decrease the dead angle as required or to increase it by removing the adjusting component. This freewheel hub also operates satisfactorily. There is the drawback of requiring a new hub. It is doubtful whether the product based on this system is already available in the market. Moreover, this known hub operates with a ratchet freewheel.

It is therefore the object of the present invention to provide a bicycle component for at least partially muscle-powered vehicles and in particular bicycles, provided with a freewheel device including a freewheel unit, wherein the freewheel function is ensured by means of a toothed disk device having an end toothing.

This object is solved by a bicycle component having the features of claim 1 and by a bicycle component having the features of claim 14. Further advantages and features of the present invention can be taken from the subclaims, the general description and the description of the exemplary embodiments.

A bicycle component according to the invention is provided for at least partially muscle-powered vehicles and in particular a bicycle. The bicycle component according to the invention comprises at least one freewheel unit of a freewheel device, wherein the freewheel unit comprises a rotary unit and a toothed disk device provided to be coupled with the rotary unit. The toothed disk device has an end toothing with axial engagement components, suitable for engaging with corresponding engagement components of another toothed disk device. The toothed disk device and the rotary unit are configured as coupling components provided to be coupled with one another, each comprising a radial toothing for intermeshing. The rotary unit and the toothed disk device are provided to rotate together around a central rotation axis. The rotary unit and the toothed disk device are movable (in particular in at least one configuration) in the peripheral direction relative to one another between a driving position for torque transmission and a rest position, such that prior to torque transmission starting, a coupling component must first be rotated in the driving direction about (a clearance angle of) at least 5°, until torque is, or can be, transmitted, if the two radial toothings have previously been in a rest position. Then or thereafter, torque can be transmitted in the driving direction when in the driving position.

The bicycle component according to the invention has many advantages. It is a considerable advantage of the bicycle component according to the invention that for example pedal kickbacks may be prevented or reduced simply and readily. The fact of movability of the rotary unit and the toothed disk device relative to one another in the peripheral direction, allows to predetermine a rotational path starting from which torque transmission will take place. This configuration is positive not only for avoiding pedal kickback. In general terms, this function may make sense in freewheel systems for providing a defined and substantially identical operation at all times. In known freewheel systems with toothed disk freewheels, a rotation angle until force transmission takes place, is dependent on the number of teeth and any random position of the two toothed disks to one another. The configuration according to the invention allows, in particular given the large quantity of axial engagement components of a toothed disk device, to always provide a substantially identical rotation angle, until torque transmission starts. This rotation angle is then defined by the circumferential distance between the driving position and the rest position.

It is another advantage of the bicycle component according to the invention that existing hubs not equipped with this feature can be retrofitted. An existing bicycle hub can be retrofitted by simply exchanging the rotary unit and/or the toothed disk device.

The invention allows reducing or preventing pedal kickbacks due to reversely driving the chain, so as to contribute to preventing rider fatigue. Even though riders do not always recognize pedal kickbacks due to uneven roadways or terrains, the acting forces are still a considerable factor in rider fatigue.

The invention allows to considerably reduce and in particular entirely prevent reverse rotation of the drivetrain including the crank. Pedal kickbacks and the resulting faster rider fatigue may lead to decisive disadvantages regarding the performance. The invention reliably reduces or nearly or entirely prevents this in a simple way.

In preferred specific embodiments, the coupling components each have a radial toothing with protruding radial teeth, alternating with radial grooves. It is preferred for the radial toothing of one coupling component to be configured as an external radial toothing and the radial toothing of the other coupling component (interacting therewith), to be configured as an internal radial toothing.

In preferred configurations, the toothed disk device has an external radial toothing, and the rotary unit, an internal radial toothing. Alternately it is possible for the toothed disk device to have an internal radial toothing interacting with an external radial toothing on the rotary unit.

In preferred configurations, in use as intended, at least one radial tooth of the external radial toothing is disposed in a radial groove of the internal radial toothing, to allow transmitting torque in the driving direction when in the driving position.

Particularly preferably, a circumferential length of at least one radial groove is considerably larger than a circumferential length of a radial tooth (on the same diameter around the central axis). Accordingly, at least one radial groove extends over a considerably larger angle at circumference than does the corresponding angle at circumference of a radial tooth. This means that the radial tooth is accommodated within the radial groove showing considerable movability (in the peripheral direction). The term “considerably larger” is understood to mean that the existing play is not only minimal as is for example required for inserting, but that considerable relative motion is possible. For example, the coupling components can pivot relative to one another about an angle of nearly 0° or 5° or 10° or 15° or 20° or more, before the radial tooth hits against the limit at the other end of the radial groove. The different circumferential lengths allow to provide for an appropriate angular displacement. In at least one configuration or position, a rotational angle of at least 5° is provided between the coupling components (between a rest position and a driving position). This rotational angle may be referred to as a clearance angle (free rotational angle). Different configurations are feasible, different configurations providing for different clearance angles. Different configurations may be different installed situations, involving the same or different components.

In simple configurations, two different toothed disk devices having different numbers of radial teeth are employed, or at least one toothed disk device is employed variously.

In preferred configurations, at least one toothed disk device is provided to be coupled with (and in particular inserted in) a rotary unit in at least two different positions. Different rotational angles are provided between the coupling components of a freewheel unit in the different positions. This means that for example radial grooves having different circumferential lengths are provided. Installation or insertion of a radial tooth (or the radial teeth) in a radial groove (or radial grooves) of appropriate length, allows suitable pivoting motions. This enables a simple way for the bicycle component to offer different, and a number of different, settings. The rider can change the settings quickly, readily, and preferably without tools. Thus, the rider may set a number of different successive settings during one single ride. It is also possible to disable the function in a configuration or position or installed situation, to thus prohibit any pivoting.

Particularly preferably, a plurality or a group of identical radial teeth and/or radial grooves is distributed over the circumference of at least one coupling component.

Preferably, at least two groups of different radial teeth and/or radial grooves (having different peripheral extensions) are distributed over the circumference of at least one coupling component. Two or three different pitches may be provided, for example. Thus, for example two different strengths of settings can be set, and for example a setting in which the two coupling components are positioned relative to one another (virtually) without play.

In preferred configurations, at least one toothed disk device is accommodated in a rotary unit provided for axial displacement.

One rotary unit may preferably be configured as a hub component. Another rotary unit may be configured as a rotor component. It is possible for one rotary unit to be configured as a hub shell and another rotary unit, as a rotor.

Particularly preferably, one rotary unit is configured as a receiving ring which is provided to be received in the hub shell non-rotatably in the driving direction. This allows for the hub shell to be manufactured for example from a lighter-weight material, while the receiving ring is formed from a firmer, heavier material. In preferred configurations, the receiving ring is configured as a threaded ring, provided with at least one thread groove on the outer circumference and provided to screw into the hub shell. In these configurations, the rotary unit may consist of the receiving ring only.

In advantageous configurations, a pre-tensioning device is provided for pre-tensioning at least one freewheel unit in the rest position. The rest position is not the driving position, as has been defined above. The rest position is not dependent on whether two toothed disk devices of a freewheel are in engagement, or whether the two toothed disk devices are disengaged from one another. The rest position of a freewheel unit is that position in which torque transmission with this freewheel unit is not (immediately) possible. A torque transmission is possible only when the two coupling components of the freewheel unit have moved into the driving position. In this case this means that the toothed disk device must first move from the rest position to the driving position in the peripheral direction relative to the rotary unit, before torque transmission is enabled through this freewheel unit. Independently thereof, an effective torque transmission requires both the toothed disk devices of a freewheel device to be in an engaged state.

The pre-tensioning device ensures that, absent any external influences, the freewheel unit remains in the rest position at all times. Such a pre-tensioning device may for example comprise one or more spring units. It is also possible to have the freewheel unit automatically move to the rest position by utilizing friction, while the rider is not pedaling.

In preferred configurations, a biasing device is comprised, biasing the two freewheel units in the axial direction to the engaging position. Such a biasing device can bias a toothed disk device of a biasing unit, or both of the toothed disk devices, in the axial direction to the engaging position via separate biasing units.

In preferred specific embodiments the biasing device also serves as a pre-tensioning device, pre-tensioning at least one freewheel unit to the rest position.

In simple configurations, the biasing device is configured as, or comprises at least one, coil spring comprising one or more windings extending around the central axis and biasing the toothed disk device to the engaging position. The ends of such a coil spring may be connected with the rotary unit or the toothed disk device, such that this biasing device also pre-tensions a freewheel unit to the rest position. This configuration is particularly simple. In comparison with conventional toothed disk freewheel hubs, it does not require any further components.

In preferred configurations, the bicycle component comprises at least one damper member accommodated between the two coupling components of a freewheel unit. The damper member may consist for example of an elastic material (for example an elastic matter or for example rubber or the like) and provide for noise reduction in particular during transfer to the driving position and/or to the rest position.

In advantageous configurations, at least one changeable adjustment unit is received on a freewheel unit, for setting and adjusting the (adapted and variable) peripheral distance respectively rotational angle between the driving position and the rest position. Exchanging the adjustment unit may provide for different settings.

In all the configurations it is possible for at least one tooth shape of at least one radial tooth to be configured angular, rounded or canted, in at least one peripheral direction.

In all the configurations it is also possible for at least one radial toothing to be configured as a radial helical toothing. This is understood to mean a toothing with the teeth provided radially inwardly and/or outwardly, and wherein the tooth flanks do not extend in parallel to the central axis but at an angle.

Another bicycle component according to the invention is provided for at least partially muscle-powered vehicles and in particular bicycles, and comprises a hub axle, a freewheel device and two rotary units. One of the rotary units is connected with the hub shell and the other of the rotary units, with the rotor (non-rotatably or integrally). The freewheel device comprises two freewheel units, one hub-side freewheel unit and one rotor-side freewheel unit. The hub-side freewheel unit comprises a rotary unit coupled with the hub shell and a hub-side toothed disk device. The rotor-side freewheel unit comprises a rotary unit coupled with the rotor and a rotor-side toothed disk device. The hub-side toothed disk device and the rotor-side toothed disk device each show an end toothing for intermeshing, and they are pre-tensioned to an axial engaging position by way of at least one biasing device. At least one rotary unit and the pertaining toothed disk device are configured as separate coupling components provided to be coupled with one another, each comprising a radial toothing for intermeshing with one another, and provided to rotate together around a central rotation axis. The rotary unit and the toothed disk device are movable relative to one another in the peripheral direction between a driving position and a rest position, such that prior to torque transmission starting, a coupling component must first be rotated in the driving direction, until torque is, or can be, transmitted, if the two radial toothings have previously been in a rest position. In the driving position, torque can then be transmitted in the driving direction.

This bicycle component according to the invention again has many advantages.

Preferably, the hub shell is rotatably supported by way of at least two axially spaced-apart hub bearings namely, at least one rotor-side hub bearing disposed closer to the rotor, and at least one outer hub bearing disposed farther distanced from the rotor. In particular is the rotor rotatably supported by way of at least two axially spaced-apart rotor bearings namely, a hub-side rotor bearing disposed closer to the hub shell, and at least one outer rotor bearing farther distanced from the hub shell.

Preferably, the end toothing of the hub-side toothed disk device is axially oriented to the rotor. Preferably, the rotor-side toothed disk device is accommodated radially inwardly of the rotor, and it is non-rotatably coupled with the rotor by way of an external radial toothing, with a radially internal toothing in the rotor in the driving direction. Preferably, the end toothing of the rotor-side toothed disk device is axially oriented to the hub shell. Particularly preferably, the clear inner diameter of the rotor-side toothed disk device is larger than the outer diameter of the hub-side rotor bearing.

In preferred configurations, the biasing device comprises at least one coil spring with a winding wire extending around a spring axis and whose winding ends are disposed inside diagonally opposite angle segments. Preferably, the hub-side rotary unit is configured as a threaded ring and is screwed into the hub shell. Other non-rotatable attachments are possible. It is also possible for the rotor-side rotary unit to be configured as a threaded ring and to be screwed into the rotor.

It is in particular possible for one of the toothed disk devices to be integrally configured with the hub shell or the rotor.

A considerable advantage of the invention consists in the simple structure and the high reliability.

The hub-side toothed disk device is received on the hub shell and comprises an end toothing which is in particular oriented toward the rotor. The rotor-side toothed disk device is accommodated on the rotor and has an end toothing in particular facing the hub shell.

Preferably, the winding wire of the coil spring extends (multiple times) around a spring axis from a first winding end to a second, diagonally/radially opposite, winding end.

Particularly preferably, the configuration may be described as follows: The projection sections of the winding ends are disposed on a (n imaginary) projection area (of an imaginary projection) of the coil spring in diagonally opposite angle segments of the projection area. Each of the angle segments extends in particular over an angular range of less than 45° and preferably less than 30°. In particular the (imaginary) projection area of the coil spring is defined respectively generated by projecting the coil spring in the direction toward the spring axis onto a plane transverse (and in particular perpendicular) to the spring axis.

Preferably, each of the angle segments extends over an angular range of less than 15°, and particularly preferably over less than 5°.

In particular is the angle at circumference between the winding ends (on the projection area) between 135° and 225°, and preferably between 150° and 210°, and particularly preferably, between 165° and 195°, or between 170° and 190°, or between 175° and 185°.

It is particularly preferred for the winding ends to be ground. This enables a particularly reliable orientation.

In all the configurations, the number of full turns of the winding wire of the coil spring is in particular between two and seven, and preferably between two and five, and particularly preferably, between two and four.

The relationship of the outer diameter of the coil spring to the diameter of the winding wire is in particular more than 10, and preferably more than 20, and it may in particular be less than 30.

Various materials may be used for the winding wires. Metallic materials are preferred.

In a preferred specific embodiment, at least the end toothing of the rotor-side toothed disk device is accommodated radially (not only in the rotor, but also radially) inwardly of the hub shell (when the hub is in the properly installed condition). The rotor-side toothed disk device is in particular accommodated radially inwardly of the hub shell, at least at one third or half, or three quarters of the axial length, or even completely. Since the rotor-side toothed disk device is radially outwardly accommodated at least partially in the radially internal toothing of the rotor, this means that the rotor-side end of the hub shell protrudes at least over a portion from the hub-side end of the rotor. Consequently, the rotor-side toothed disk device is radially surrounded both by the rotor and also by the hub shell.

In particular are the rotor-side toothed disk device, the hub-side rotor bearing and a rotor-side hub flange on the hub shell, located on a shared plane of cross section transverse to the axis of symmetry of the hub or transverse to the longitudinal extension of the hub axle. This allows a compact architecture combined with reliable function. The architecture is simple, enabling optimal transfer of the forces occurring. The hub axle in particular extends through the hub shell, the two toothed disk devices, and through the rotor, and preferably accommodates a limit stop at each of its ends.

In advantageous specific embodiments, the hub-side toothed disk device is accommodated radially inwardly of the hub shell, and is coupled with the hub shell by way of an external radial toothing on the hub-side toothed disk device with a radially internal toothing in the hub shell to be non-rotatable in the driving direction.

Particularly preferably, both the hub-side toothed disk device and the rotor-side toothed disk device can be transferred from an engagement position to a freewheel position, each against the biasing force of at least one biasing device. It is particularly preferred for both the hub-side toothed disk device and the rotor-side toothed disk device to be assigned to a biasing device each. For example, the biasing devices on the whole may comprise one or several mechanical or magnetic springs. If both the toothed disk devices are urged to one another from the outside or pulled to one another by a suitable mechanism, this enables a particularly reliable freewheeling function and provides the structural design of a high-quality hub.

If both the toothed disk devices are separately biased to an engagement position, any jamming or tilting or some other disorder to any of the toothed disk devices can be compensated by the other of the toothed disk devices. To this end, the two toothed disk devices are accommodated in particular floatingly. Thus, a three-dimensional tilting of any toothed disk device can be equalized by a corresponding three-dimensional tilting of the other of the toothed disk devices. Furthermore, when two separate biasing devices are employed, any malfunction of a biasing device may also be compensated. These measures considerably increase the reliability. Thus, in combination with the particularly large outer diameter of the radial toothings, a particularly reliable hub is provided. The high guiding quality due to the large outer diameters on the radial toothings results in only minor three-dimensional tilting. Optionally, such tilting is reliably compensated by the two biasing devices. This applies all the more since the toothed disk device can pivot relative to the rotary unit from the rest position to the driving position, and the guide can therefore be not quite tight.

Particularly preferably, the clear inner diameter of the hub-side toothed disk device is larger than the outer diameter of the rotor-side hub bearing. This allows placement of the rotor-side hub bearing axially closer to the rotor. Thus, the rotor-side hub bearing and the hub-side rotor bearing can be disposed virtually immediately adjacent to one another. Then, the toothed disk devices surround the pertaining bearing radially outwardly.

Preferably, roller bearings, provided with a plurality of rolling members each, are employed for at least one hub bearing and for at least one rotor bearing. Preferably, deep-groove ball bearings are used, provided with an inner ring and an outer ring. A spacer is preferably provided between the rotor-side hub bearing and the hub-side rotor bearing. The spacer provided may for example be a thin disk or a short sleeve, to enable independent rotation of the pertaining outer ring of the relatively closely adjacent roller bearing.

In all the configurations it is particularly preferred for the hub shell with the hub bearings to be supported for rotation in particular immediately on the hub axle. It is likewise preferred for the rotor with the rotor bearings to be supported for rotation preferably immediately on the hub axle. It is also conceivable for a hub bearing or a rotor bearing to be disposed on a type of sleeve or the like, which in turn is accommodated or disposed on the hub axle.

In all the configurations it is particularly preferred for a central plane of cross section to intersect the rolling members of the hub-side rotor bearing through the rotor-side toothed disk device. It is preferred for a central plane of cross section to intersect the rolling members of the rotor-side hub bearing through the hub-side toothed disk device. A “central plane of cross section” is in particular understood to mean a mean or center plane of cross section located in the axial center of the pertaining toothed disk device. Such a central plane of cross section may for example extend in the axial direction, centrally through the radial toothing of the toothed disk device when the hub is in the idle position. In the idle position, the freewheel devices are in the engaged position, and as a rule, the two toothed disk devices are located in a central axial area, and they can be displaced in both axial directions against the biasing force of the biasing device.

In preferred configurations, the axial distance of the central plane of cross section through the rotor-side toothed disk device from the plane of cross section through the rolling members (plane of rolling member) of the hub-side rotor bearing, is smaller than the diameter of a rolling member and in particular smaller than the radius of a rolling member, and/or smaller than the minimum wall thickness of the hub axle. This enables a particularly efficient transfer of forces.

It is preferred for the axial distance of the central plane of cross section through the hub-side toothed disk device, from the plane of cross section through the rolling members of the rotor-side hub bearing, to be smaller than the diameter of a rolling member, and in particular smaller than the radius of a rolling member and/or smaller than the minimum wall thickness of the hub axle.

In preferred configurations, the outer diameter of the rotor-side toothed disk device is larger than the outer diameter of the sprocket accommodation. This permits a particularly reliable function and shows a particularly large toothed disk device, since the standardized sprocket accommodation has an outer diameter that is smaller than the outer diameter of the rotor-side toothed disk device. Particularly preferably, the outer diameter of the end toothing of the rotor-side toothed disk device is larger than the outer diameter of the sprocket accommodation. This clearly shows that the end toothing is located on a very large diameter and provides a large contact surface.

Particularly preferably, a plurality of teeth is provided, wherein the toothed disk may be configured with 48, 60, 72, 80, 90, 100, 110 or 120 or more teeth. For example, both the toothed disk devices may show the same quantity of for example 90 or 120 (+/−10) teeth. It is also conceivable for the number of teeth of the two toothed disk devices to be different, at any rate as long as the pitch and placement of each of the axial teeth on the end toothing is identical.

In all the configurations it is possible and preferred for the end toothing to be configured on an end face of a toothed disk device. The end face is in particular configured transverse and in particular perpendicular to the axis of rotation. Alternately it is possible for the end toothing to be configured as a bevel gear, thus showing an inclination to a plane perpendicular to the axis of symmetry. What is essential is, for the two toothed disk devices to be configured fitting and matching one another, to allow a permissible engagement of the pertaining tooth segments with one another.

Preferably, the hub-side toothed disk device shows an external radial toothing which is in engagement with a radially internal toothing in the hub shell, relative to which it is axially movable. This means that the hub-side toothed disk device is axially movable relative to the internal toothing in the hub shell. The radially internal toothing in the hub shell does not need to be configured immediately in the hub shell, but it can for example be configured on a threaded ring which is accommodated in the hub shell and in particular screwed into the hub shell.

A separate threaded ring allows, in case of wear or the like, to exchange the threaded ring only, while allowing continued use of the hub shell.

It is possible for the threaded ring to be manufactured from a stronger material than the hub shell. For example, the threaded ring may be manufactured of steel. Alternately it is possible for the threaded ring to be manufactured from a more lightweight material such as aluminum or titanium or a suitable alloy. In case that wear shows in the radial toothing in the threaded ring, it may be removed and exchanged as required.

In preferred specific embodiments, the threaded ring shows a central depression and in particular a centered depression on the axially outer surface. The central depression may be a conical depression. A conical portion configured on the end face of the rotor plunges into the central depression preferably contactless (in the properly installed condition). This allows a compact structure. Moreover, a (narrow) sealing gap may be configured between the conical portion and the conical depression.

Particularly preferably, the threaded ring is configured on the radially external surface (considerably) wider in the axial direction than on the radially internal surface. This may be caused by the central depression, so that the axial width is larger radially outwardly by at least 5% or 10% or preferably more than 15% or even 20%, than radially inwardly. The axial width, in particular radially outwardly, is larger by 10% to 25%, than radially inwardly.

In preferred specific embodiments, the threaded ring shows, on the axially inner surface facing away from the rotor, a (conical) support portion resting against a correspondingly (conically) configured accommodation in the hub shell. A suitable, conical configuration of the support portion and the accommodation in the hub shell allows saving axial mounting space. A support portion configured orthogonal to the central axis of symmetry and a correspondingly orthogonal accommodation allow greater ease of manufacture.

In particular does the external thread of the threaded ring extend axially outwardly beyond the hub-side toothed disk device, and extends up to radially beyond the rotor-side toothed disk device, which it overlaps at least partially. Such a configuration allows enlarging the plane of action of the threaded ring, while not requiring more mounting space in the axial direction.

Preferably, the external thread of the threaded ring comprises at least two separately configured and continuous thread grooves. Preferably, the internal thread in the hub shell comprises at least two separately configured and continuous thread grooves. Thus, a thread may be configured which allows a high bearing load while simultaneously requiring small axial forces during pedalling.

Basically, during riding, the driving force of the rider pushes the threaded ring further into the hub shell, since the driving force is transmitted through the external radial toothing of the toothed disk device and the radially internal toothing to the threaded ring. Thus, a screw-in momentum is generated, which may result in the hub shell spreading. A multiple thread allows to lower the load in the hub shell when the same strength is applied, to prevent spreading of the hub shell.

In all the configurations it is preferred that at least one toothed disk device comprises an engagement body on which the end toothing is configured over the radial height, and the radial toothing is configured over the axial length. The axial length of the radial toothing is in particular larger than the radial height of the end toothing. The axial length may in particular be at least 1.5 times the radial height. This ensures a very reliable and precise axial guide for the toothed disk device.

In particular is the axial extension of the engagement body larger than the diameter of a rolling member of a rotor bearing and/or a hub bearing. Preferably, the axial extension of the engagement body is larger than half or ⅔ of the axial width of a roller bearing and in particular larger than half or ⅔ of the axial width of the hub-side rotor bearing. The axial width of the engagement body is in particular at least 5 mm and preferably at least 6 mm. The axial width may in particular be between 4.5 mm and 8 mm. In a concrete configuration, the axial width of the radial toothing of a toothed disk device is 6.16 mm, while the clear inner diameter is between 25 mm and 35 mm, and in a concrete configuration, approximately 30 mm. The outer diameter (including the radial toothing) of the toothed disk device is preferably between 30 mm and 40 mm, and in a specific case, it may be 37.8 mm.

The threaded ring has in particular an axial length between 5 mm and 10 mm. Preferably, the axial length of the threaded ring is 7 mm (+/−1 mm). The outer diameter of the threaded ring may be between 35 and 45 mm and in a concrete example, approximately 44 mm. The clear inner diameter of the radially internal toothing in a concrete example is 30 mm.

The central depression or conical depression of the axially outer surface of the threaded ring preferably has an angle between 15° and 45°, and in a preferred configuration it may be approximately 30°. This results in a depth of the conical depression of for example 0.9 or 1 mm. Preferably, at the end face of the rotor, the conical portion has a correspondingly adapted angle. The angle may be identical, but it may also be different.

In preferred configurations, the axial length of the radial toothing is larger than the radial height of the end toothing and in particular larger by at least a factor of 1.5.

Preferably, the distance of the two central planes of cross section through the rotor-side toothed disk device and the hub-side toothed disk device is smaller than the axial width of the two toothed disk devices in the engaged state (or position). In particular, the distance of the two central planes of cross section through the rotor-side toothed disk device and the hub-side toothed disk device is smaller than twice the axial length of the radial toothing of an engagement body of at least one toothed disk device. It is possible and preferred for the distance of the two planes of cross section to be smaller than 1.2 times or 1 time the axial width of the threaded ring.

Particularly preferably, the hub-side toothed disk device and the rotor-side toothed disk device are configured substantially identical. This means that preferably, identical engagement bodies are employed for the two toothed disk devices. In particular, substantially the same or even identical biasing devices are used. Preferably, biasing springs are used. For example coil springs or conical coiled springs. These can also provide for the pre-tension in the rest position in the peripheral direction.

Further advantages and features of the present invention can be taken from the exemplary embodiments which will be discussed below with reference to the enclosed figures.

The figures show in:

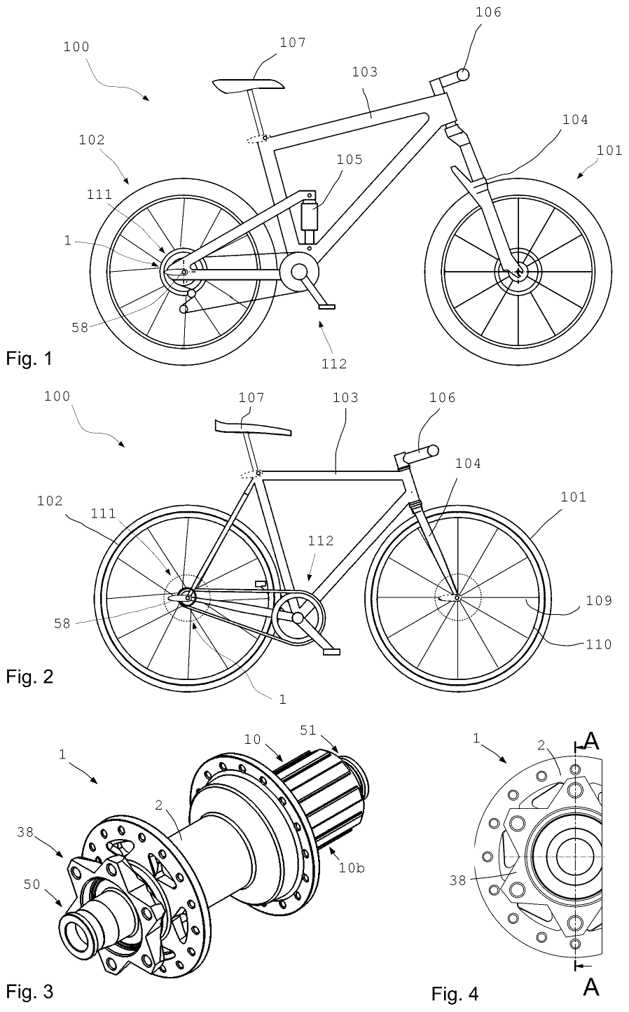

FIG. 1 a schematic illustration of a mountain bike;

FIG. 2 a schematic illustration of a racing bicycle;

FIG. 3 a perspective illustration of a hub according to the application;

FIG. 4 a front view of the hub according to FIG. 3;

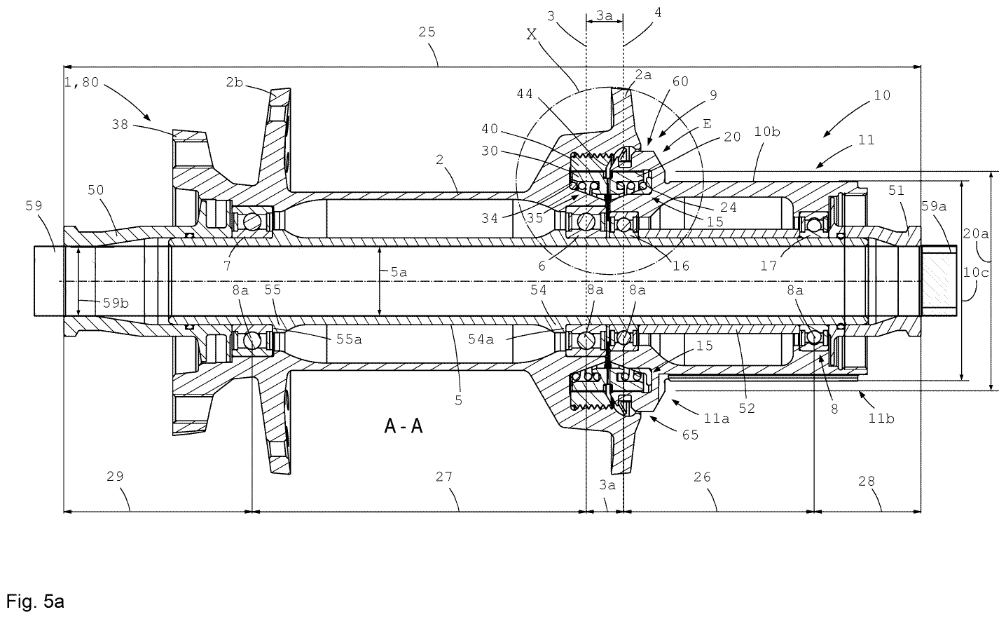

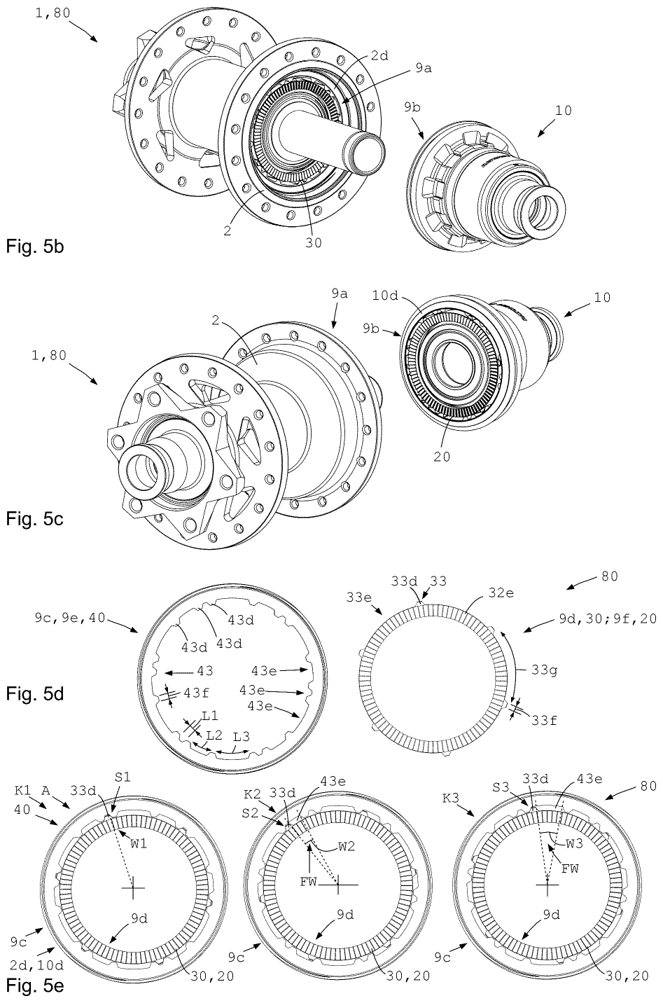

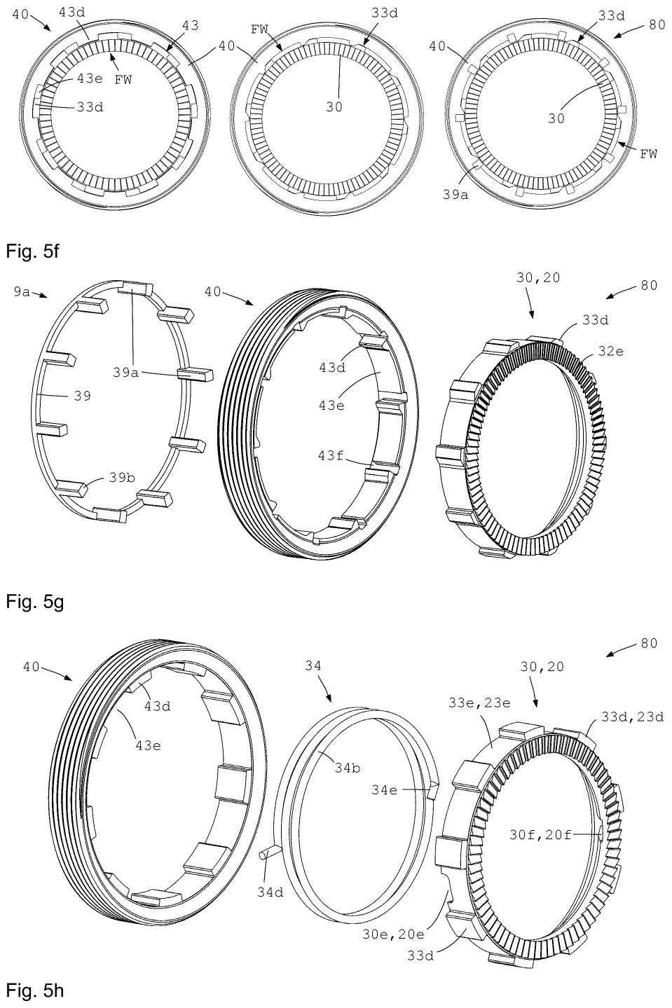

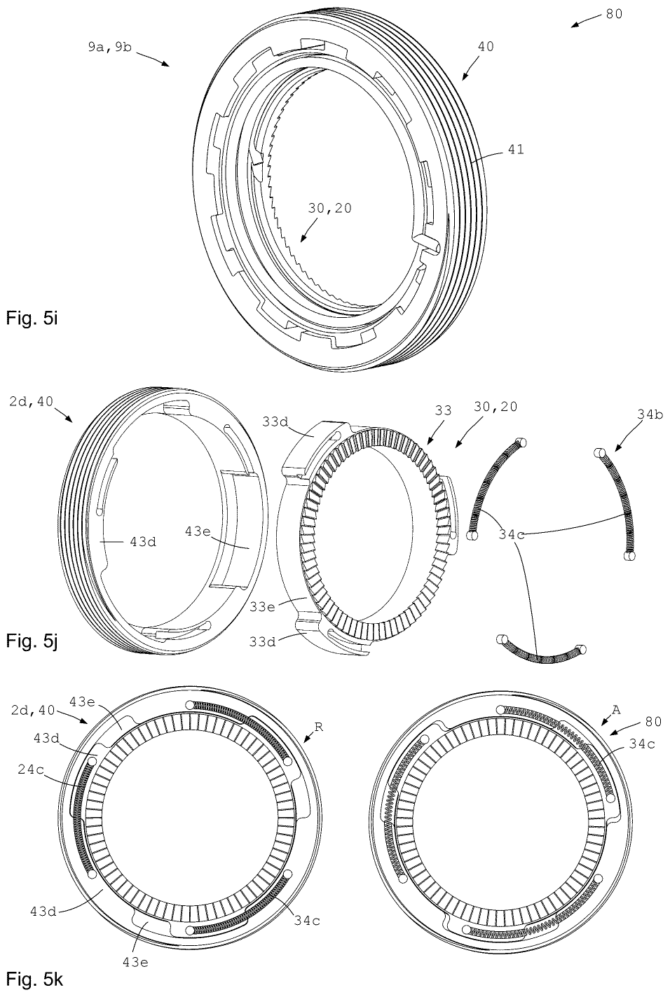

FIG. 5a a cross section A-A through the hub according to FIG. 4;

FIGS. 5b, 5c configurations of bicycle components according to the invention in perspective views;

FIGS. 5d-5k views of various bicycle components according to the invention;

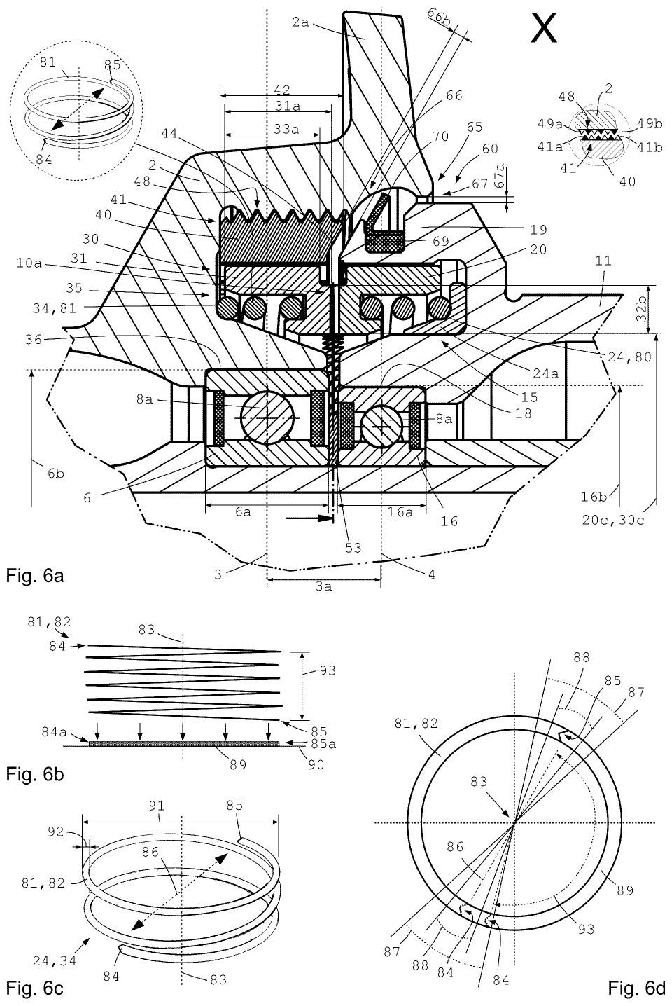

FIG. 6a an enlarged detail “X” from FIG. 5a;

FIGS. 6b-d views of a coil spring of a biasing device;

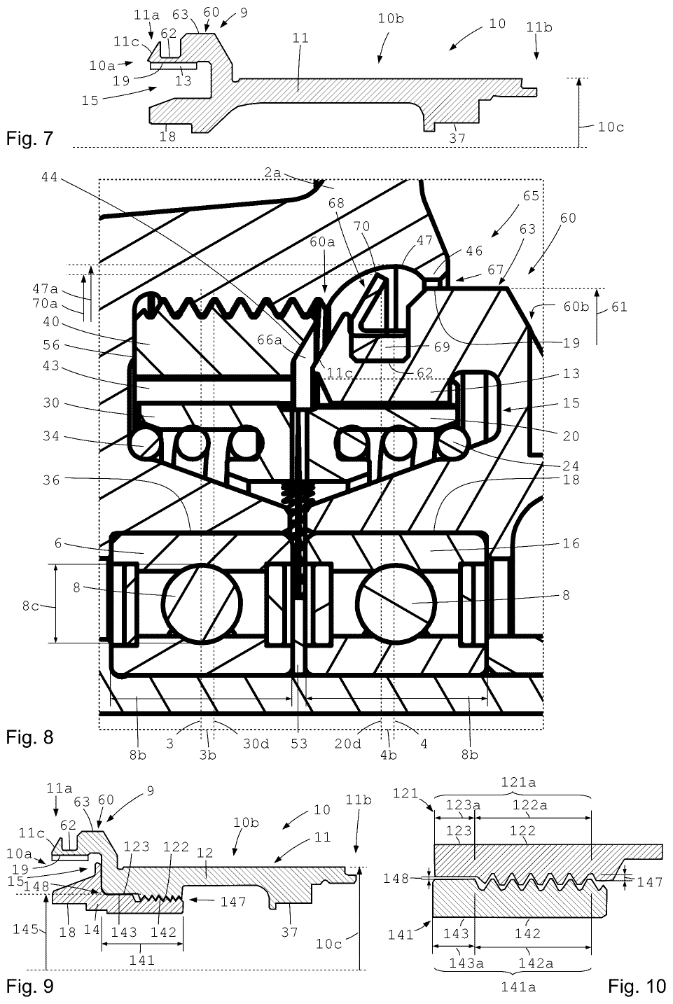

FIG. 7 a schematic, cross sectional view of the rotor of the hub according to FIG. 5;

FIG. 8 an enlarged detail of a variant of a hub according to the application;

FIG. 9 a schematic, cross sectional view of a two-piece rotor for a hub according to the application;

FIG. 10 a schematic detail of the two-piece rotor according to FIG. 9;

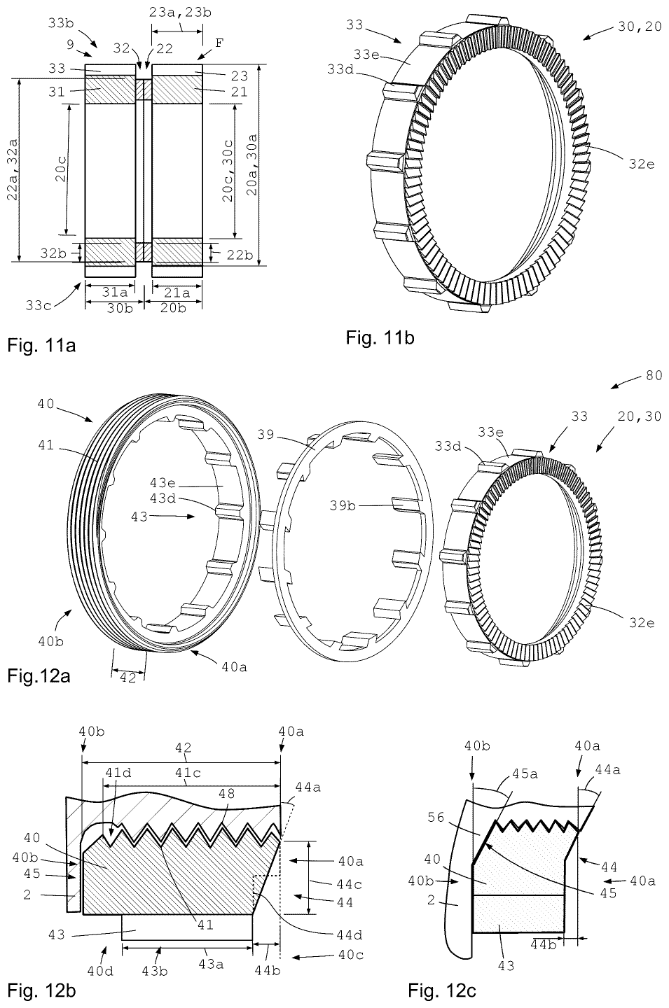

FIGS. 11a, b schematic views of a freewheel device and the toothed disk device for a hub according to the application; and

FIGS. 12a-c a schematic perspective view and schematic cross sections of a threaded ring for a hub according to the application.

The FIGS. 1 and 2 illustrate a mountain bike respectively a racing bicycle 100, each of which is equipped with a bicycle component 80 according to the invention, configured as a hub 1. The mountain bike or racing bicycle 100 is provided with a front wheel 101 and a rear wheel 102. A hub 1 is inserted in each of the rear wheels 102. The two wheels 101, 102 comprise spokes 109 and a rim 110 and a sprocket assembly 111. Basically, conventional caliper brakes or other brakes, for example disk brakes may be provided.

A bicycle 100 comprises a frame 103, a handlebar 106, a saddle 107, a fork or suspension fork 104 and in the case of the mountain bike, a rear wheel damper 105 may be provided. A pedal crank 112 with pedals serves for driving. Optionally the pedal crank 112 and/or the wheels may be provided with an electric auxiliary drive. The hub 1 of the wheels may be attached to the frame by means of a clamping mechanism 58 (for example a through axle or quick release).

The hubs 1 inserted in the rear wheels 102 in the bicycles according to FIGS. 1 and 2 are shown in FIG. 3 in perspective, and in FIG. 4 in a front view.

The hub 1 comprises a hub shell 2 and a rotor 10, and a brake disk accommodation 38. The outer surface of the rotor 10 is provided with a sprocket accommodation 10b to accommodate a sprocket cluster having an appropriate quantity of sprockets. The two ends of the hub 1 are provided with limit stops 50, 51, presently shown pushed on, but they may optionally be pushed in or screw-fastened. As can be seen, the limit stops 50, 51 are configured hollow and serve to accommodate a clamping axle 59 with which to fasten the hub 1 to the frame.

FIG. 5a shows the cross section A-A of FIG. 4. The hub 1 presently has a fitted length 25 of 148 mm. The hub 1 comprises the hollow hub axle 5, on which the hub shell 2 is supported for rotation by way of the hub bearings 6 and 7. The rotor 10 is presently supported for rotation immediately on the hub axle 5, likewise by way of the roller bearings 16 and 17.

On the hub axle 5, closer to the rotor 10, a bulge 54 with a radial shoulder 54a is configured, and at the outer end beneath the hub flange 2b, a bulge 55 with a radial shoulder 55a is configured. The rotor-side hub bearing 6 rests against the radial shoulder 54a, and the outer hub bearing 7 disposed at the other end of the hub shell 2 rests against the shoulder 55a of the hub axle 5. Axially outwardly, the limit stop 50 follows the outer hub bearing 7, which is presently pushed onto the hub axle 5, sealing the hub shell outwardly by means of a double flange protruding outwardly.

Toward the rotor 10, the rotor-side hub bearing 6 is followed by a (thin, and presently disk-shaped) spacer 53 and thereafter, by the hub-side rotor bearing 16. Between the hub-side rotor bearing 16 and the outer rotor bearing 17, a sleeve 52 acting as a spacer is pushed onto the hub axle 5. Axially outwardly, the limit stop 51 follows the outer rotor bearing 17. The hub 1 is fixedly clamped into the frame.

The hollow hub axle 5 shows an inner clear diameter 5a which, depending on the configuration, may be 12 mm, 15 mm, or 16 mm or 17 mm or more. A clamping axle 59 of a clamping mechanism 58 can be pushed through the hollow hub axle 5 for attaching the hub 1 to the frame of a bicycle. At one of its ends, the clamping axle 59 may comprise for example an end piece 59a with an external thread, with which to screw the clamping axle 59 into a matching thread on the frame. At the other of its ends, a corresponding clamping mechanism may be provided, to reliably accommodate and clamp the hub 1 to a frame.

The outer diameter 59b of the clamping axle 59 and the inner diameter 5a of the hollow hub axle 5 are matched to one another such that on the one hand, a (relatively) unimpeded passage of the clamping axle through the hollow hub axle 5 is enabled, while on the other hand, the hollow hub axle 5 can also be supported on the clamping axle 59 in operation, if the loads applied result in local deflection. In this way, the stability of the hub 1 on the whole is increased.

Alternately it is also possible to omit this additional support. Then, a clamping axle 59 is employed, showing a noticeable radial distance between the hub axle 5 and the clamping axle 59 over large parts of the hub axle 5, to not at all, or to a very minor extent, affect the insertion or removal of the clamping axle.

According to the application, the hub bearings 6 and 7 and also the rotor bearings 16 and 17 are each configured as roller bearings 8, each comprising a plurality of rolling members 8. In this exemplary embodiment, all the roller bearings are configured as deep-groove ball bearings.

The hub 1 is fixedly clamped into the frame in the axial direction. The force flow proceeds for example from the left end in FIG. 5a through the limit stop 50, the inner bearing ring of the outer hub bearing 7 and through the shoulder 55a of the bulge 55 into the hollow hub axle 5. From there, the introduced force is guided over the shoulder 54a of the bulge 54 into the inner bearing ring of the hub bearing 6 and through the spacer 53 between the rotor-side hub bearing and the hub-side rotor bearing 16. From there, the force enters into the inner bearing ring of the hub-side rotor bearing 16 and is guided over the sleeve 52 to the inner bearing ring of the outer rotor bearing 17 and from there through the limit stop 51, back into the frame. The hub shell 2 and the rotor 10 are radially and axially retained by way of the deep-groove ball bearings.

On the rotor side, the hub shell 2 has a hub flange 2a, and on the other side, a hub flange 2b. The spokes can be attached to the hub flanges 2a, 2b. Opposite the rotor 10, the other, outer hub end is provided with the brake disk accommodation 38.

Radially inwardly of the rotor-side hub flange 2a, a threaded ring 40 is screwed into the hub shell, comprising a radially internal toothing 43 in which the hub-side toothed disk device 30 is inserted. On the hub-side end of the rotor 10, radially within the end portion 60, the rotor-side toothed disk device 20 of the freewheel device 9 is inserted. The end portion 60 extends from the hub-side end 60a on the hub-side end face 10a axially outwardly, through to the other, outer end 60b.

Both the rotor-side toothed disk device 20 and the hub-side toothed disk device 30 comprise an external radial toothing 23, 33 each, meshing with corresponding radially internal toothings 43 in the threaded ring 40 and in the interior of the end portion 60. Thus, the rotor-side toothed disk device 20 and the hub-side toothed disk device 30 are non-rotatably coupled with the rotor 10 respectively the hub shell 2 in the driving direction in the driving position “A”.

At the same time, both of the toothed disk devices 20, 30 can each be moved in the axial direction between an engagement position E and a freewheel position F. Due to the end toothing respectively helical toothing (on the front face), the oblique tooth faces of the end toothing slip off each other during backpedaling, urging the toothed disk devices 20, 30 apart in the axial direction. When driving force is applied, the end toothings re-engage with one another, following a rotation of the coupling components (hub-side and/or rotor-side) from the rest position “R” back to the driving position “A”.

The toothed disk device 20 is pre-tensioned by way of the biasing device 24, presently in the shape of a cylindrical coil spring, to the engagement position E illustrated.

Correspondingly, the toothed disk device 30 is axially pre-tensioned to the engagement position E, by way of a pre-tensioning device or biasing device 34, which is also configured as a cylindrical coil spring. This means that the hub-side toothed disk device 30 is pre-tensioned in the direction toward the rotor, while the rotor-side toothed disk device 20 is biased in the direction toward the hub shell 2, by means of the pre-tensioning device or biasing device 24. The action of the biasing device can be effected by means of mechanical springs, or magnetic springs, or pneumatically.

At the same time, at least one toothed disk device 20, 30 is urged to the rest position “R”, when the rider is not pedaling. It is possible for only one toothed disk device 20, 30 to be pivotable between the rest position “R” and the driving position “A”, and pre-tensioned to the rest position “R”. Alternately it is possible for both the toothed disk devices 20, 30 to be pivotable between a rest position “R” and the driving position “A”. The pertaining pivoting angles may be identical or different.

The rotor 10 comprises a rotor body 11, extending from the hub-side end 11a to the opposite, outer end 11b. On the outer surface of the rotor body 11, the sprocket accommodation 10b is provided. This is where a sprocket or several sprockets, or a sprocket cluster, can be attached.

On the hub-side end 11a, the end portion 60 having an enlarged diameter is configured. Inside of the end portion 60 the rotor-side toothed disk device 20 is accommodated, which comprises an outer diameter 20a which is larger than the outer diameter 10c of the sprocket accommodation 10b of the rotor body 11. The outer diameter 30a corresponds to the outer diameter 20a. The axial widths 20b and 30b are identical as well.

As can be clearly seen in FIG. 5a, the planes of rolling member respectively planes of cross section 3, 4 each also intersect the toothed disk devices 20, 30 (through the rolling members 8a of the rotor-side hub bearing 6 and the hub-side rotor bearing 16). It can be seen that the plane of rolling member respectively plane of cross section 4 runs through the hub-side rotor bearing 16, the biasing device 24, and the radial toothing of the rotor-side toothed disk device 20, and through the hub flange 2a of the hub shell. Furthermore, a sealing unit 68 disposed radially outwardly on the end portion 60 is intersected by the plane of cross section respectively plane of rolling member 4.

Such a configuration, in which the planes of cross section respectively planes of rolling member 3 and 4 intersect the engaging portions of the radial toothings of the two toothed disk devices and each of the assigned roller bearings 6, 16, offers an optimal transfer of the loads occurring in operation. The distance 26 of the two rotor bearings 16, 17 may be selected very large, since the rotor-side toothed disk device 20 is disposed radially outwardly of the hub-side rotor bearing 16, surrounding it radially. The distance 27 of the two hub bearings 6, 7 may likewise be selected very large, since the hub-side toothed disk device 30 is also disposed radially outwardly of the rotor-side hub bearing 6, surrounding it radially.

The clear inner diameters 20c, 30c of the two toothed disk devices are (considerably) larger than the outer diameters of the pertaining roller bearings 6, 16. The clear inner diameters 20c, 30c (see FIG. 6) are considerably larger, since on the outer diameters 6b, 16b, the roller bearings 6, 16 each support an inner wall 18, 36 of the rotor 10 respectively the hub shell 2, which extend toward one another finger-like beneath the accommodations 15, 35.

The accommodation 15, in which the rotor-side toothed disk device 20 is non-rotatably received, is configured radially outwardly of the inner wall 18 at the rotor. The accommodation 35, in which the hub-side toothed disk device 30 is non-rotatably received on the threaded ring 40, is configured radially outwardly of the inner wall 36 in the hub shell.

With a mounting width 25 of for example 148 mm, this structural design allows a distance 27 of the two hub bearings between 55 mm and 60 mm, and presently specifically for example 57 mm. The distance 3a of the two planes of cross section 3, 4 may be very narrow, and may presently be for example 7 mm, 8 mm or 9 mm. The distance 26 of the two rotor bearings 16, 17 may be between 27 mm and 35 mm, and presently it is for example 32 mm. The distance 28 may be 18 mm, and the distance 29 may be 33 mm.

The FIGS. 5b and 5c show perspective views of hub components 80 respectively bicycle hubs 1 according to the invention, each provided with a hub shell 2 and a rotor 10, equipped with two freewheel units 9a and 9b by way of a freewheel device 9. The toothed disk devices 20 respectively 30 are received in the rotary units 10d and 2d respectively.

FIG. 5d shows a first configuration of a bicycle component 80, which comprises the coupling components 9c and 9d. The receiving ring 40 forms the coupling component 9c, presently configured as a threaded ring 40 provided for screwing into the hub shell 2. The receiving ring 40 has a radial toothing 43, presently configured as a radially internal toothing, and equipped with a plurality of radial teeth 43d distributed over the inner periphery. Radial grooves 43e are configured respectively disposed between all the radial teeth 43d, wherein the circumferential lengths L1, L2 and L3 of different radial grooves 43e show significant differences. The circumferential widths 43f of the radial teeth 43d are configured identically.

To the right of the receiving ring 40, a toothed disk device 30 or 20 is shown, which may serve as a coupling component 9d or 9f. In this exemplary embodiment, the toothed disk devices 20 and 30 are identical in configuration. Alternately it is possible for the two toothed disk devices 20, 30 to differ from one another. One of the toothed disk devices may e.g. be configured conventionally, not permitting circumferential rotation relative to the rotary units 2d or 10d.

The toothed disk device 30 shown is provided with a radial toothing 33, which is configured as an external radial toothing and provided with a plurality of radial teeth 33d. The radial teeth 33d alternate with radial grooves 33e, which show a circumferential length 33g, which is considerably larger than the circumferential length 33f of a radial tooth 33d.

The outer dimensions of the receiving ring 40 and the toothed disk 30 (20) are matched to one another such that the toothed disk 30 (20) can be received in the interior of the receiving ring 40. The radial teeth 33d (23d) can be inserted into the radial grooves 43e (23e). Depending on which of the radial grooves 43e (23e) the radial teeth 33d (23d) are received in, the toothed disk 30 (20) is received in the receiving ring 40 (rotor 10 respectively rotary unit 10d) with or without play. Insertion into the radial grooves 43e having a circumferential length L1 provides for only slight angular adjustability or none at all. Inserting the radial teeth 33d into radial grooves 43e having a circumferential length L2 provides for medium adjustability, and inserting into radial grooves 43e having a circumferential length L3, large angular adjustability.

A number of groups of radial grooves 43d are provided over the circumference respectively inner periphery of the receiving ring 40.

FIG. 5e shows three different installed situations (configurations K1-K3 or positions S1-S3), on the left, inserting the toothed disk 30 with the radial teeth 33d into the radial grooves 43e having the smallest circumferential length L1 (configuration K1). An angular displacement W1 between the two coupling components 9d and 9f is (virtually) impossible, since the two coupling components are connected with one another basically without play. Axial movement is possible to enable the freewheel function, but angular displacement is not.

The middle illustration shows the toothed disk 30 (20) inserted into the radial grooves 43e having a medium circumferential length L2 (configuration K2), resulting in a clearance angle FW having an angular adjustability W2 of the two coupling components 9d, 9f relative to one another.

On the right, FIG. 5e illustrates the toothed disk 30 (20), with the radial teeth 33d (23d) in the largest radial grooves 43e having a circumferential length L3 (configuration K3). This results in a clearance angle FW having an angular adjustability W3, which is considerably larger than the angular adjustability W2. Adjustment of 10° or 15° is possible. Greater or smaller adjustability may be selected.

FIG. 5f shows three variants, illustrating different contour configurations of the radial teeth 33d, 43d, and the radial grooves 33e and 43e. The radial teeth and radial grooves may be configured with (nearly) rectangular edges or with the edges canted on one side or rounded. A flank may progress radially on one side or on both sides, or may be inclined on one or both sides. On the right in FIG. 5f, the receiving ring 40 also accommodates damper members 39a allowing noise damping.

FIG. 5g shows a variant in which an annular member 39 with damper members 39a or adjustment members 39b is inserted, to either dampen noises in operation, and/or to enable adapting the angular displacement respectively adjustment of travel between the driving position and the rest position. The dimensions of the damper members 39a respectively adjustment members 39b may be varied appropriately. Simply exchanging the annular member 39 allows short-term changes to the properties.

FIG. 5h shows a variant wherein the biasing device 34 does not only axially bias the toothed disk device 30 (or 20) into the direction of engagement, but also pre-tensions it in the peripheral direction in the rest position. The biasing device 34 also serves as a pre-tensioning device 34b, causing relative rotational movement of the two coupling components respectively the toothed disk 30 (20) relative to the receiving ring 40 (rotor 10), such that the freewheel unit 9a (9b) in FIG. 5h is in the rest position in the normal case (without pedaling). The angular ends 34d and 34e can be positioned in the appropriate cutouts 30e, 30f (20e, 20f) of the toothed disk device 30 (20) to ensure the function.

FIG. 5i shows the exemplary embodiment according to the preceding Figure in a perspective view in the assembled state. One can see the freewheel unit 9a with the toothed disk device 30 (or 20) received therein, the outer circumference showing a thread groove 41 of the external thread of the receiving ring 40, presently configured as a threaded ring.

FIG. 5j shows another configuration, wherein a separate pre-tensioning device 34b is provided, comprising three separate spring units 34c, received in the receiving ring 40 in the peripheral direction as a rotary unit 2d. On one end, the spring units 34c are connected with the rotary unit 2d (respectively 10d) in the peripheral direction and at the other end, with the toothed disk device 30 (respectively 20). Thus, the three spring units 34c pull the toothed disk device 30 into the rest position “R”, when the rider is not pedaling.

FIG. 5k shows a front view of the exemplary embodiment or a slight modification according to FIG. 5j, wherein the rest position “R” is shown on the left, and the driving position “A”, on the right.

FIG. 6a shows the enlarged detail X from FIG. 5a. On the hub axle 5 one can recognize the rotor-side hub bearing 6 having a width 6a and its hub-side rotor bearing 16 having a width 16a, between which a thin spacer 53 can be seen. The spacer 53 serves to decouple from one another the two outer bearing rings of the bearings 6, 16. The width of the spacer 53 is narrower than half or a quarter or an eighth of the axial width 16a of the hub-side rotor bearing 16.

The rotor-side hub bearing 6 supports a wall 36 of the hub shell 2, which extends finger-like and in particular wedge-like or tapered toward the rotor 10, surrounding the rotor-side hub bearing 6 radially outwardly. The hub shell 2 is supported by the wall 36. The accommodation 35 is configured radially around, accommodating the hub-side toothed disk device 30. The hub-side toothed disk device 30 is pre-tensioned by the biasing device 34 to the engagement position E.

The toothed disk device 30 comprises an external radial toothing 33 (see FIG. 11b), which meshes with a radially internal toothing 43 (see FIG. 12a) in the receiving ring 40 respectively threaded ring 40. The threaded ring 40 is screwed into the internal thread 48 in the hub shell 2 by way of the external thread 41.

On the hub-side end face 10 of the rotor 10, an accommodation 15 is configured in which the rotor-side toothed disk device 20 is accommodated. The rotor-side toothed disk device 20 comprises an end toothing 22 oriented to the hub shell. The end toothing 22 meshes with the end toothing 32 on the hub-side toothed disk device 30. The toothed disk devices 20, 30 are each axially urged to one another by means of the biasing devices 24, 34.

The holder respectively insert 24a, in the accommodation 15 on the hub-side end face 10 of the rotor 10, enables the use of identical toothed disk devices 20, 30, to provide for ease of installation, since confusion can be excluded. In terms of manufacturing technique, the accommodation 15 must be configured larger, to allow manufacture of the radially internal toothing 13 in the end portion 60 of the rotor 10. The conditions in the accommodations 15, 35 are identical.

Basically, identical toothed disk devices 20, 30 may be used, even though angular displacement of a freewheel unit 9a, 9b is only possible on one side. To this end it may make sense to design the exterior so that a toothed disk device 20, 30 can be inserted into two rotary units 2d, 10d, where it is functional. Even if only one side allows for angular displacement between the rest position “R” and the driving position “A”.

The axial width 33a of the radial toothing 33 of the hub-side toothed disk device 30 and the (preferably) identical axial width 23a of the radial toothing 23 of the rotor-side toothed disk device 20, may in particular be larger than the axial width 16a or the axial width 6a of the roller bearing 6 respectively 16.

The axial width 42 of the threaded ring 40 is larger radially outwardly, since on the rotor side, the threaded ring has a central depression 44, which is presently configured as a conical depression respectively chamfer 44 (see FIG. 12b). This allows to enlarge the thread length of the external thread 41, thus increasing the stability.

The engagement bodies 21, 31 of the rotor-side toothed disk device 20 and the hub-side toothed disk device 30 each have a radial toothing 23, 33 over an axial length 23a respectively 33a, which is clearly larger than is the radial height 22b respectively 32b of the end toothing 22 respectively 32. This ensures a precise guide for the two toothed disk devices in the axial direction. The axial length 21a, 31a of the engagement bodies 21, 31 is larger by the axial width of the end toothings.

The threaded ring 40 may be screw-connected with the hub shell 2 by means of a multiple thread. FIG. 6 shows on the top right an optional configuration, wherein two continuous and separate thread grooves 41a and 41b are screw-connected with corresponding thread grooves 49a and 49b in the hub shell 2.

The sealing device 65 for sealing the freewheel device 9 against environmental influences comprises a nearly horizontally configured (outer) narrow sealing gap 67 having a low radial height respectively clear dimension 67a of less than 0.5 mm. The outer sealing gap 67 extends between an enlarged diameter area 63 at the end portion 60 and a radially inwardly protruding wall 46 at the hub shell 2.

From there axially inwardly, a groove 62 is configured radially outwardly on the end portion 60, which accommodates a sealing unit 68 with a ring portion 69. An elastic sealing lip extends from the ring portion 69 obliquely outwardly out of the groove 62, so that a V-shaped cross section results between the ring portion 69 and the elastic sealing lip 70, which is opened axially outwardly toward the outer sealing gap 67. The sealing lip 70 protrudes into a peripheral groove 47 (see FIG. 8).

Axially further inwardly, a conical gap 66a respectively cone gap follows, having a clear gap width 66b. Overall, the sealing device 65 therefore comprises three sealing gaps, firstly the cone gap 66a, then the gap between the elastic sealing lip 70 and the wall of the sealing groove 47 in the hub shell, and the outer sealing gap 67 between the outer wall 19 in the enlarged diameter area 63 on the end portion 60 of the rotor 10.

FIG. 6a once again clearly shows that the plane of cross section 4 extends through the rolling members 8a of the hub-side rotor bearing 16, through the radial toothing 23, and through the sealing unit 68, and the rotor-side hub flange 2a. The hub-side rotor bearing 16 supports the inner radial wall 18 of the rotor body 11. Radially outwardly thereof, the accommodation 15 is disposed in which the rotor-side toothed disk device 20 is non-rotatably accommodated, coupled with the rotor 10.

On the top left, FIG. 6a additionally shows a simplistic and perspective view of the coil spring 81 (or 82) of a biasing device 24, 34 of the hub 1, which is described in more detail with reference to FIG. 6c. At any rate, it can be seen that the coil spring 81 shows (at least approximately) diagonally opposite winding ends 84, 85. Even in unfavorable conditions, this enhances the alignment of the toothed disk devices 20, 30. The coil spring 81 may also serve for pre-tensioning a freewheel unit to the rest position “R” in the peripheral direction.

The simple structure allows to reliably prevent errors in installation and to improve the function.

FIG. 6b shows a schematic side view of a coil spring 81, 82 of a biasing device 24, 34 of the hub 1. The two ends 84, 85 of the coil spring 81, 82 terminate offset to one another by (about) 180°, lying diagonally opposite one another, but displaced axially offset to one another along the spring axis 83. The coil springs 81, 82 shown have exactly one winding wire 82 each, extending/being wound, around the spring axis 83. Although the winding wire 82 may extend cylindrically, it may assume a generally (slightly) tapered or conical shape. The configuration shown is cylindrical. The number of windings 93 may in particular be 2.5 or 3.5 or 4.5 or 5.5. The additional half winding causes the winding ends 84, 85 to be diagonally opposite. Angular ends 34d, 34e, not visible, of the coil springs 81, 82 may serve to engage in appropriate takeups 20e, 30e respectively 20f, 30f.

FIG. 6b also indicates a projection area 89 onto a plane 90 transverse, and in particular perpendicular, to the spring axis 83. The (imaginary) projection area 89 emerges from a projection respectively the “shadow casting” of the coil spring 80, 81 onto the plane 90. The projection section 84a of the winding end 84 lies diagonally to the projection section 85a of the winding end 85. The (imaginary) projection takes place in the direction of, respectively in parallel to, the spring axis 83.

FIG. 6c shows a perspective view of the coil spring 80, 81, allowing to recognize the diameter 92 of the winding wire 82 in comparison to the outer diameter 91 of the coil spring 80, 81. The relationship shown is between 20 and 30, at about 25.

FIG. 6d shows a top view of a coil spring 80, 81, and thus the afore-mentioned (imaginary) projection area 89. The winding ends 84, 85 are drawn in, lying in diagonally opposite angle segments 88 respectively 87. One angle segment 87 is less than 30°, and in particular less than 15°. In the example shown, the angular distance of the two winding ends 84, 85 is 180°.

Additionally shown in broken lines is, another variant of a winding end 84, wherein the angle at circumference 93 drawn in between the winding ends 84, 85 is only approximately 165°. Alternately, measurements may be taken on the other side, so as to show approximately 195°, since the two angles together must add up to 360°.

The configuration of the coil springs 80, 81 achieves an improvement of the freewheeling system. The optimized coil spring allows to achieve a reduction of mis-engagements (skips) and a reduction of the risk of mis-engagement.

In operation, the biasing devices 24, 34 need to engage in, respectively couple with, one another very fast and precisely. In analyses of problematic missed engagements (skips) it has been found that such a coil spring, when in the compressed state, causes a further improved reaction force. Due to the arrangement of the coil springs in pairs on both the biasing devices 24, 34, this leads to improved properties. In freewheeling, the biasing devices 24, 34 twist relative to one another. In the worst-case scenario (“worst case position”) the two coil springs 80, 81 are offset 180° to one another. In this condition, this configuration of the coil springs 80, 81 prevents an extremely inhomogeneous force, and improves the engagement behavior.

FIG. 7 shows a schematic cross section through the rotor body 11 of the rotor 10, which extends from the hub-side end 11a toward the outer end 11b. On the outer surface of the rotor body 11, the sprocket accommodation 10b is provided, showing an outer diameter 10c which is smaller than the diameter of the internal radial toothings 13 on the accommodation 15 for the rotor-side toothed disk device 20.

The enlarged diameter area 63, which provides a wall of the sealing gap 67, is located on the end portion 60. The sealing unit 68 can be disposed in the peripheral groove 62. On the hub-side end 11a, the conical portion 11c is configured, forming, together with the conical depression 44 on the threaded ring 40, the inner sealing gap 66 respectively cone gap 66a. Radially inwardly one can see the inner radial wall 18, against which the rotor 10 is supported on the hub-side rotor bearing 16.

FIG. 8 shows an enlarged detail of a variant of FIG. 6, wherein, unlike the configuration according to FIG. 5a, identically sized roller bearings 6, 16 (with identical widths 8b) are used as the hub-side rotor bearing 16 and the rotor-side hub bearing 6. This further facilitates installation and storage, since the quantity of different parts is further reduced. Again, the rotor-side toothed disk device 20 is accommodated in the takeup 15 of the rotor body 11. The radially internal toothing 13 on the outer wall 19 guides the radial toothing 23 of the rotor-side toothed disk device 20 in the axial direction. The biasing device 24 urges the end toothing 22 in the direction toward the hub shell.

The outer diameter 70a of the elastic sealing lip 70 is larger than the outer diameter 61 of the outer sealing gap 67. This results in that water penetrating axially through the sealing gap 67 causes deformation of the sealing lip 70, so that it rests (more forcefully) against the wall of the sealing groove 47, obtaining a still higher sealing effect.

The central plane of cross section 20d (central plane of toothed disk) through the radial toothing 23 of the rotor-side toothed disk is distant only by a slight distance 4b from the plane of cross section 4 (plane of rolling member) through the rolling members 8a of the hub-side rotor bearing 16. The distance 4b between the planes of cross section 20d and 4 is in particular less than half the diameter respectively the radius of a rolling member 8, and particularly preferably, it is also less than the smallest wall thickness of the hollow hub axle 5. This applies accordingly to the central plane of cross section 30d through the axial center of the radial toothing of the rotor-side toothed disk device 30. Again, the distance 3b between the two planes of cross section 3 (plane of rolling member) and 30d (central plane of toothed disk) is very small and in particular smaller than half the diameter or half the radius of a rolling member 8a of the rotor-side hub bearing 6.

The central plane of cross section 20d through the radial toothing 23 intersects the rolling members 8a of the hub-side rotor bearing 16. The central plane of cross section 30d through the radial toothing 33 also intersects the rolling members 8a of the rotor-side hub bearing 6. This effectively allows to dissipate the highest forces. The distances 3b and 4b are very small and smaller than half the diameter 8c or even half the radius of the rolling members 8a.

FIG. 9 shows a modification of the rotor 10, presently consisting of two rotor parts 12 and 14. The rotor body 11 comprises a first rotor part 12, which provides the sprocket accommodation 10b. Furthermore, on the first rotor part 12 the wall 37 is configured, by means of which the rotor 10 is supported on the hub axle 5 by way of the outer rotor bearing 17. On the second rotor part 14, the inner radial wall 18 is configured, by means of which the rotor 10 is supported on the hub-side rotor bearing 16 for rotation around the hub axle 5.

The second rotor part 14 is screw-connected with the first rotor part 12. To ensure exact guiding and concentric running, which is in particular important for the rotor, the first rotor part 12 and the second rotor part 14 each comprise a connecting area 121 and a connecting portion 141. The connecting area 121 comprises a threaded area 122 and a guiding area 123. The connecting portion 141 comprises a threaded portion 142 and a guiding portion 143. The guiding portion 143 has a diameter 145.

A length 141a of the connecting portion 141 of the second rotor part 14 in particular corresponds to at least ¼ or ⅓ of the length 14a of the second rotor part 14, in particular between a quarter and half of the length of the rotor body 11.

The ratio of the length 143a of the guiding portion 143 to the diameter 145 of the guiding portion 143 is higher than 1:10. Preferably, the ratio of the length 143a of the guiding portion 143 to the length 141a of the connecting portion 141 is higher than 1:4.

In the installed condition, the threaded area 122 and the threaded portion 142 are screw-connected. The required centering is effected by the guiding area 123 and the guiding portion 143. The radial tolerance in the guiding portion 143 is less than the radial tolerance between the threaded area 122 and the threaded portion 142.

FIG. 10 shows the interaction of the connecting area 121 and the connecting portion 141 in an enlarged, schematic illustration. The connecting area 121 extends over a length 121a, which is composed of the length 122a of the threaded area 122 and the length 123a of the guiding area 123.

Accordingly, on the second rotor part 14, a connecting portion 141 is configured, which extends over a length 141a. The connecting portion 141 is composed of the threaded portion 142 and the guiding portion 143, which extend over a length 142a respectively 143a. The threaded area 122 (respectively the threaded portion 142) has a narrower tolerance 148 than does the screw-connected guiding area 123 (respectively guiding portion 143) having a tolerance 147. This ensures high precision and repeatability of the radial orientation of the rotor 10.

FIGS. 11a and 11b show the toothed disk devices 20, 30, presently identical, each having an engagement body 21, 31 and an end toothing 22, 32, and an external radial toothing 23, 33. The external radial toothings 23, 33 extend in the axial direction over an axial length 23a, 33a. The axial extension 21a, 31a of the engagement bodies 21, 31 is, at least by the axial width of the end toothings 22, 32, larger than the axial length 23a, 33a of the external radial toothings 23, 33. The clear inner diameter 20c is larger than the outer diameter of the roller bearings 6, 16. The outer diameter 22a, 32a is larger than the outer diameter 10c of the sprocket accommodation 10b.

The number of teeth of the end toothing is preferably higher than 72, and it may be 90, 100, 110 or 120 or more.

The external radial toothings 23, 33 of the toothed disk devices 20, 30 and the radially internal toothings 13, 43 preferably have between 3 and 20 radial teeth. In the exemplary embodiment shown in FIG. 11b, one of the toothed disk devices 20, 30 comprises about twelve radial teeth.

The radial extension 22b, 32b of the end toothings 22, 32 is less than the axial length 23a, 33a of the radial toothings 23, 33.

FIG. 11b shows the axial engagement components 32e and the radial teeth 33d protruding outwardly, and the radial grooves 33e disposed in-between.

Reference is made to the fact that in all the configurations and modifications, the axial engagement components 32e cannot only be disposed on a surface transverse to the central axle, but they may be disposed on a more or less conical surface.

The FIGS. 12a, 12b and 12c show variants of the threaded ring 40, each comprising an axial width 42, and on the outer periphery, comprising a preferably multiple thread, with which to screw the threaded ring into a corresponding thread in the hub shell 2.

FIG. 12a shows a configuration, wherein once again, an annular member 39 is illustrated with a damper member 39a or adjustment member 39b, to enable controlled setting, and in particular reducing, the properties of the bicycle component.

FIG. 12b shows a variant wherein at the rotor-side end 40a of the threaded ring 40, a central depression 44, presently in the shape of a chamfer respectively conical depression 44, is configured running at an angle 44a of for example 30° and comprising a depth 44b.

The threaded ring 40, when properly mounted, is screwed into the hub shell 2. The hub-side toothed disk device 30 of the freewheel device 9 is accommodated therein. The end toothing 32 faces in the direction of the rotor 10 and is pre-tensioned to the engagement position (E) by means of a biasing device 24.

The threaded ring 40 has an outer contour 41d with an external thread 41, and comprises a central through hole 40c with an inner contour 40d. The inner contour 40d comprises a non-round inner coupling contour 43b, which is non-rotatably coupled in the driving direction in the drive position “A”, with a matching non-round outer coupling contour 33b on the outer periphery 33c of the hub-side toothed disk device 30. The inner coupling contour 43b may extend over the entire length or only part of the length of the inner contour 40d.

The threaded ring 40 may have a central depression 44 at the rotor-side end 40a, so that the external thread 41 on the threaded ring 40 extends in the direction to the rotor 10 axially further outwardly than does the inner coupling contour 43b. This allows to widen the external thread 41 of the threaded ring 40 in the direction toward the rotor 10. An improved accommodation of the threaded ring 40 in the hub shell 2 is possible. The strength is improved. The external thread 41 is extended.

Thus, the axial length 41c of the external thread 41 is larger than the axial length 33a of the coupling structure, which comprises the inner coupling contour 43b and the outer coupling contour 33b. The threaded ring 40 is screwed into the internal thread 48 of the hub shell 2 by means of the external thread 41.

The hub-side toothed disk device 30 is accommodated radially inwardly of the threaded ring 40 by way of the coupling structure 33b, 43b, non-rotatably in the driving direction in the drive position “A”, and axially movable. At the rotor-side end 40a, the threaded ring 40 has a central, and presently centered, depression 44. The axial width 41c of the external thread 41 is wider than the axial width 33a of the coupling structure.

In the variant according to FIG. 12b, the central depression 44 is configured as a conical depression. In all the exemplary embodiments, the depression 44 has an axial depth 44b of at least 5% (and in particular at least 10%) of the axial width 42 of the threaded ring 40. The axial length 41c of the outer contour 41d of the threaded ring 40 is larger than the axial length 43a of the radially internal toothing 43 (which is the inner coupling contour 43b).

The axial depth 44b of the central depression 44 is between 5% and 25% of the axial width 42 of the threaded ring 40, and preferably between 10% and 20% of the axial width 42 of the threaded ring 40. The axial depth 44b of the central depression 44 is preferably between 0.5 mm and 3 mm.

In all the configurations, the central depression 44 may be stepped and for example configured as a stepped depression 44d, as is for example indicated in broken lines in FIG. 12b.

Also possible is, a stepped and conical configuration. Preferably, the central depression 44 is configured conical or convex as a centric chamfer. An angle or cone angle 44a of the (conical) depression 44 to a plane transverse to the axis of symmetry of the hub or hub axle, is in particular between 5% and 30°.

In the mounted condition, a conical portion 11c configured on the end face 10a of the rotor 10, plunges contactless into the central depression 44 on the threaded ring 40. A sealing gap is configured in-between.

At the other end 40b, a conical support portion 45 may be configured (see FIG. 12c), extending at the conical angle 45a (for example) 30°. Such a conical support portion 45 allows saving axial mounting space. Alternately it is possible to configure the support portion 45 perpendicular to the axis of symmetry. This facilitates manufacture.

Overall, an advantageous bicycle component 80 is provided, which is simple in structure. The bicycle component 80 may be configured as a hub 1 and is easy to install, and comprises a relatively small number of parts. High stability is achieved. A high number of teeth of the end toothing can provide a narrow engagement angle, wherein the pivotability reliably prevents any “kickback”. The bicycle component 80 may be provided as an exchange kit, which allows retrofitting an existing hub with the function.

The configuration of the rotor-side toothed disk device 20 in the accommodation 15 in the rotor allows to provide a compact hub 1, in which the rotor-side toothed disk device 20 is guided in the inner radial toothing 13 of the rotor. This ensures a high quality, axial guiding. The large diameter of the radial toothing and thus of the axial guide prevents tilting and jamming and provides for a reliable function.

List of reference numerals:

| | |
|---|---|
| 1 | hub |
| 2 | hub shell |
| 2a, 2b | hub flange |
| 2d | rotary unit |
| 3 | plane of cross section, plane of rolling member |
| 3a | distance of 3, 4 |
| 3b | distance 3, 30d |
| 4 | plane of cross section, plane of rolling member |
| 4b | distance 4, 20d |
| 5 | hub axle |
| 5a | through hole |
| 5b | rotation axis |
| 6 | rotor-side hub bearing |
| 6a | axial width |
| 6b | outer diameter |
| 7 | outer hub bearing |
| 8 | roller bearing |
| 8a | rolling member |
| 8b | axial width |
| 8c | diameter 8a |
| 9 | freewheel device |
| 9a, 9b | freewheel unit |
| 9c-9d | coupling component (hub) |
| 9e-9f | coupling component (rotor) |
| 10 | rotor |
| 10d | rotary unit |
| 10a | hub-side end face |
| 10b | sprocket accommodation |
| 10c | outer diameter 10b |
| 11 | rotor body |
| 11a | hub-side end |
| 11b | outer end |
| 11c | conical portion |
| 12 | first rotor part |
| 121 | connecting area |
| 121a | length of 121 |
| 122 | threaded area |
| 122a | length of 122 |
| 123 | guiding area |
| 123a | length of 123 |
| 13 | radially internal toothing |
| 14 | second rotor part |
| 141 | connecting portion |
| 141a | length of 141 |
| 142 | threaded portion |
| 142a | length of 142 |
| 143 | guiding portion |
| 143a | length of 143 |
| 145 | diameter of 143 |
| 147 | tolerance of 142/122 |
| 148 | tolerance of 143/123 |
| 15 | accommodation, takeup |
| 16 | hub-side rotor bearing |
| 16a | axial width |
| 16b | outer diameter |
| 17 | outer rotor bearing |
| 18 | inner radial wall |
| 19 | outer wall |
| 20 | rotor-side toothed disk device |
| 20a | outer diameter |
| 20b | axial width |
| 20c | clear inner diameter |
| 20d | central plane of cross section |
| 21 | engagement body |
| 21a | axial extension |
| 22 | end toothing |
| 22a | outer diameter |
| 22b | radial height |
| 22e | engagement component |
| 23 | radial toothing |
| 23a | axial length |
| 23d | radial tooth |
| 23e | radial groove |
| 24 | biasing device |
| 24a | holder |
| 25 | fitted length |
| 26, 27 | bearing distance |
| 28 | distance |
| 29 | distance |
| 30 | hub-side toothed disk device |
| 30a | outer diameter |
| 30b | axial width |
| 30c | clear inner diameter |
| 30d | central plane of cross section |
| 30e | recess for 34d |
| 30f | recess for 34e |
| 31 | engagement body |
| 31a | axial extension |
| 32 | end toothing |
| 32b | radial height |
| 32e | engagement component |
| 33 | radial toothing |
| 33a | axial length |
| 33b | outer coupling contour |
| 33c | outer periphery |
| 33d | radial tooth |
| 33e | radial groove |
| 33f | circumferential length of 33d |
| 33g | circumferential length of 33e |
| 34 | biasing device |
| 34b | pre-tensioning device |
| 34c | spring unit |
| 34d | spring end (angled) |
| 34e | spring end (angled) |
| 15 | accommodation, takeup |
| 36 | inner wall |
| 37 | wall |
| 38 | brake disk accommodation |
| 39 | annular member |
| 39a | damper member |
| 39b | adjustment member |
| 40 | receiving ring, threaded ring |
| 40a | rotor-side end, axially outer surface |
| 40b | hub-side end, axially inner surface |
| 40c | central through hole |
| 40d | inner contour of 40 |
| 41 | external thread |
| 41a, b | thread groove |
| 41c | axial length |
| 41d | outer contour |
| 42 | axial width |
| 43 | radially internal toothing |
| 43a | axial length |
| 43b | inner coupling contour |
| 43d | radial tooth |
| 43e | radial groove |
| 43f | receiving groove |
| 44 | central depression, conical depression |
| 44a | angle |
| 44b | depth |
| 44c | height |
| 44d | stepped depression |
| 45 | (conical) support portion |
| 45a | angle |
| 46 | sealing wall |
| 47 | sealing groove |
| 47a | diameter |
| 48 | thread in 2 |
| 49a, b | thread groove |
| 50, 51 | limit stop |
| 52 | sleeve body |
| 53 | spacer |
| 54, 55 | radial bulges |
| 54a | shoulder |
| 55a | shoulder |
| 56 | accommodating contour (conical) |
| 58 | clamping mechanism |
| 59 | clamping axle |
| 59a | end piece |
| 59b | diameter |
| 60 | end portion |
| 60a | hub-side end (60) |
| 60b | other end of 60 |
| 61 | diameter |
| 62 | groove |
| 63 | enlarged diameter area |
| 65 | sealing device |
| 66 | inner sealing gap |
| 66a | cone gap |
| 66b | clear gap width |
| 67 | outer sealing gap |
| 67a | clear dimension |
| 68 | sealing unit |
| 69 | ring portion |
| 70 | sealing lip/elastic wall |
| 70a | outer diameter |
| 80, 81 | coil spring |
| 82 | winding wire |
| 83 | spring axis |
| 84 | winding end |
| 84a | projection section of 84 |
| 85 | winding end |
| 85a | projection section of 85 |
| 86 | diagonal |
| 87 | angle segment |
| 88 | angle segment |
| 89 | projection area |
| 90 | plane transverse to 83 |
| 91 | diameter of 80, 81 |
| 92 | diameter of 82 |
| 93 | angle at circumference |
| 100 | bicycle |
| 101 | wheel, front wheel |
| 102 | wheel, rear wheel |
| 103 | frame |
| 104 | fork, suspension fork |
| 105 | rear wheel damper |
| 106 | handlebar, handle |
| 107 | saddle |
| 109 | spoke |
| 110 | rim |
| 111 | sprocket assembly |
| 112 | pedal crank |
| FW | clearance angle |
| F | freewheeling state |
| E | engagement position |
| A | driving position |
| R | rest position |
| L1-L3 | circumferential length |
| S1-S3 | positions |
| W1-W3 | rotational angle |

1. A bicycle component for an at least partially muscle-powered vehicle
having at least one freewheel unit of a freewheel device;
wherein the freewheel unit comprises a rotary unit and a toothed disk device provided to be coupled with the rotary unit;
wherein the toothed disk device comprises an end toothing with axial engagement components, suitable for engaging with corresponding engagement components of another toothed disk device;
wherein the toothed disk device and the rotary unit are each configured as coupling components provided to be coupled with one another, and each comprising a radial toothing for engagement with one another and which are rotatable together around a central rotation axis;
in at least one configuration the rotary unit and the toothed disk device are movable in the peripheral direction relative to one another between a driving position and a rest position, such that prior to torque transmission starting, a coupling component is first rotated in the driving direction about a clearance angle of at least 5°, until torque can be transmitted, when the two radial toothings have previously been in the rest position.

2. The bicycle component according to claim 1, wherein the coupling components each comprise a radial toothing with protruding radial teeth and radial grooves disposed in-between, and wherein the radial toothing of one of the coupling components is configured as an outer radial toothing and the radial toothing of the other of the coupling components interacting therewith, is configured as an inner radial toothing.

3. The bicycle component according to claim 2, wherein, at least one radial tooth of the outer radial toothing is disposed in a radial groove of the inner radial toothing, to allow transmitting torque in the driving direction when in the driving position.

4. The bicycle component according to claim 2, wherein the circumferential length of at least one radial groove is considerably larger than the corresponding circumferential length of a radial tooth on a, or the same, diameter around the central axis.

5. The bicycle component according to claim 3, wherein at least one toothed disk device is provided to be coupled with a rotary unit in at least two different positions, wherein in the different positions, different rotational angles are provided between the coupling components of a freewheel unit.

6. The bicycle component according to claim 4, wherein a plurality of identical radial teeth and radial grooves is distributed over the circumference of at least one coupling component.

7. The bicycle component according to claim 6, wherein at least two groups of different radial teeth and/or radial grooves are distributed over the circumference of at least one coupling component.

8. The bicycle component according to claim 1, wherein at least one toothed disk device is received axially displaceably in a rotary unit.

9. The bicycle component according to claim 1, wherein a rotary unit is configured as a hub part, and/or a rotary unit is configured as a rotor part.

10. The bicycle component according to claim 1, wherein a pre-tensioning device pre-tensions at least one freewheel unit to the rest position in the peripheral direction.

11. The bicycle component according to claim 1, wherein a biasing device biases the two freewheel units to the engaging position in the axial direction.

12. The bicycle component according to claim 10, wherein the biasing device serves as a pre-tensioning device, and pre-tensions at least one freewheel unit to the rest position.

13. The bicycle component according to claim 1, wherein at least one damper member is received between the two coupling components of a freewheel unit, and/or wherein a changeable adjustment unit is received on a freewheel unit, for setting and adjusting the peripheral distance between the driving position and the rest position.

14. A bicycle component for at least partially muscle-powered vehicles, comprising; a hub axle, a freewheel device and two rotary units; wherein one of the rotary units is connected with a hub shell and the other, with the rotor;
wherein the freewheel device comprises two freewheel units, one hub-side freewheel unit and one rotor-side freewheel unit;
wherein the hub-side freewheel unit comprises a rotary unit coupled with the hub shell and a hub-side toothed disk device;
and wherein the rotor-side freewheel unit comprises a rotary unit coupled with the rotor and a rotor-side toothed disk device;
wherein the hub-side and the rotor-side toothed disk devices each comprise an end toothing for engagement with one another, and which are pre-tensioned by means of at least one biasing device to an (axial) engaging position;
wherein at least one rotary unit and the pertaining toothed disk device are configured as separate coupling components, provided to be coupled with one another, and comprising one radial toothing each for engagement with one another, which are rotatable together around a central rotation axis;
at least one configuration, the rotary unit and the toothed disk device are movable in a peripheral direction relative to one another between a driving position and a rest position about a clearance angle of at least 5°, such that prior to torque transmission starting, a coupling component is first rotated in the driving direction, until torque is, or can be, transmitted, when the two radial toothings have previously been in a rest position.

15. The bicycle component according to claim 14, wherein the hub shell is rotatably supported by way of at least two axially spaced-apart hub bearings namely, at least one rotor-side hub bearing disposed closer to the rotor, and at least one outer hub bearing disposed farther distanced from the rotor,
and wherein the rotor is rotatably supported by way of at least two axially spaced-apart rotor bearings namely, a hub-side rotor bearing disposed closer to the hub shell, and at least one outer rotor bearing farther distanced from the hub shell.
